(19) United States
(12) Patent Application Publication
(10) Pub. No.: US 2011/0120032 A1
(43) Pub. Date: May 26, 2011

(54) BLAST MITIGATION SAFETY GLASS SYSTEM

(76) Inventor: Carl P. Kernander, Northwood, NH (US)

(21) Appl. No.: 12/948,090

(22) Filed: Nov. 17, 2010

Related U.S. Application Data
(60) Provisional application No. 61/261,934, filed on Nov. 17, 2009.

(51) Int. Cl. F41H 5/26; E06B 3/30; E04B 1/92; E04H 9/04

(52) U.S. Cl. 52/203; 52/741.3

(57) ABSTRACT

The present invention provides a mechanical attachment system for attaching window film to the window frame, such as a batten, profile clamp or other structural device (referred to generally throughout the application as “attachment device”), which attachment device absorbs energy instead of simply transferring energy to the window frames (as is done in traditional devices). The absorption of energy is accomplished by incorporation of a flex area in the attachment device. The flex area bends or flexes when acted upon by blast loads and effectively eliminates the tearing effect (of the film) that all conventional mechanical attachment systems exhibit.

### CROSS REFERENCE TO RELATED APPLICATION

This application claims the benefit of U.S. Provisional Patent Application No. 61/261,934, filed Nov. 17, 2009, the entirety of which is hereby incorporated by reference into this application.

### BACKGROUND OF THE INVENTION

1. Field of the Invention

The present invention relates to safety windows. More specifically the present invention related to mechanical anchoring system for safety film to window frames.

2. Description of Related Art

Windows are the single most dangerous part of a building to the occupants within the building. The powerful blast from a bomb can cause immeasurable destruction. A single square foot of glass can produce up to 200 deadly, razor-sharp fragments. In many instances, flying glass shards are what cause severe injury and even death. It is generally recognized around the world that between 80% and 90% of injuries or death in a bomb blast are due to cuts by the glass from the windows.

Historically, to achieve high levels of blast protection for existing glass, heavy gauge safety films were used in conjunction with various mechanical attachment systems. The safety films are designed to prevent the shattered glass from being propelled into a structure, where it can cause severe injury to occupants. In order to insure that the filmed glass remains within the frame, the film is attached to the window frame by metal “batten” systems that capture the edges of the film while being screwed into the frame. One such clamp is shown in FIG. 1. These attachment systems are frequently referred to as “Load Transfer Members” because they transfer the energy from the blast through the film directly into the frame.

It would be desirable to find a mechanical attachment system that absorbs blast energy and reduces the transfer of energy to the window frames. It would be desirable to increase the blast load of windows without increasing the amount of lamination on the window.

### SUMMARY OF THE INVENTION

The present invention provides a mechanical attachment system for attaching window film to the window frame, such as a batten, profile clamp or other structural device (referred to generally throughout the application as “attachment device”), which attachment device absorbs energy instead of simply transferring energy to the window frames (as is done in traditional devices). The absorption of energy is accomplished by incorporation of a flex area in the attachment device. The flex area bends or flexes when acted upon by blast loads and effectively eliminates the tearing effect (of the film) that all conventional mechanical attachment systems exhibit.

The mechanical attachment system of the present invention functions to keep the filmed glass within the frame during a blast event. During installation a film is wrapped behind the batten or profile clamp or other structural device (collectively referred to as the attachment device). The attachment device is then attached to the window frame with screws, thereby securing the film between the attachment device and the window frame. This system also preferably utilizes a rubber gasket attached to the attachment device which is positioned between the window film and the edge of the attachment device. The gasket serves the function of decreasing the shearing effect along the perimeter of the window.

Unlike conventional mechanical attachment systems, which merely transfer energy to the window frame, the inventive attachment system absorbs energy. In the present invention, every part of the system is designed to absorb a portion of the total energy, but no one piece absorbs all of the energy. The problem with conventional attachment systems is that they function to put a significant portion of the total energy into the frame. In particular, conventional profile clamps transfer nearly all of the energy to the window frame. In contrast, the inventive attachment system contains a flex area in the attachment device, which absorbs energy before it reaches the window frame.

The flex area in attachment device is designed to bend or flex but not break, and does not pull away from the window frame. The flex area is constructed in a way that the bending or flexing requires a lot of energy. This energy that is used to bend or flex the flex area is energy, therefore, that is not transferred to some other window component such as the window frame. As a result, significantly less energy is directed to the window frame or the screws holding the clamp to the window. The window can therefore be subjected to significantly greater force while still being held in place in the window frame.

### BRIEF DESCRIPTION OF THE DRAWINGS

For a better understanding of the present invention, reference may be made to the accompanying drawings.

FIG. 1 shows a close up side view of a length of a prior art mechanical clamp.

FIG. 2 shows a perspective view of a length of one embodiment of the attachment device made in accordance with the present invention.

FIG. 3 shows a second perspective view of a length of one embodiment of the attachment device made in accordance with the present invention.

FIG. 4 shows a side view of a length of one embodiment of the attachment device made in accordance with the present invention.

FIG. 5 is a side by side comparison of a length of one embodiment of the attachment device made in accordance with the present invention before and after subjected to a blast load.

### DETAILED DESCRIPTION OF THE PREFERRED EMBODIMENT

In the mechanical attachment system of the current invention, an attachment device is used to attach or secure window film to the frame of a window. In one embodiment the attachment device is a mechanical clamp 1, alternatively referred to as a batten or profile clamp. Other attachment devices, however, may be used so long as the device functions to absorb energy from the blast instead of merely transferring the energy to the window frame. The film used can be any film typically used in the industry, such as SafetyShield® Window Film sold by Madico, Inc.

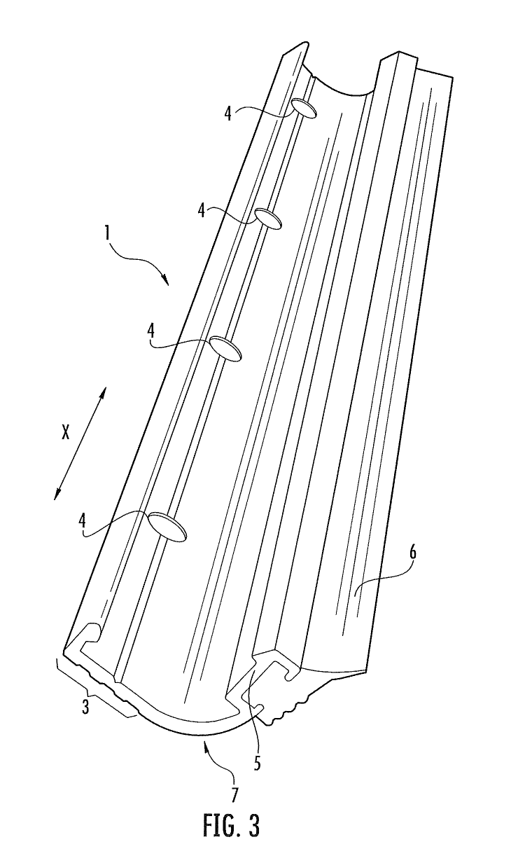

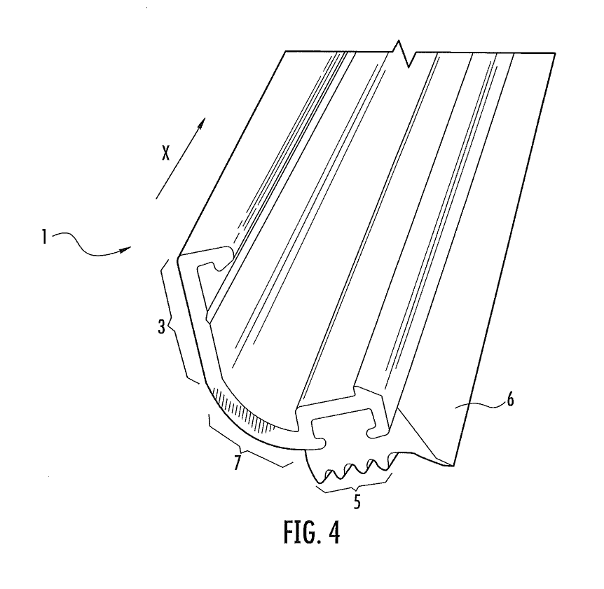

FIGS. 2-4 are drawing of various views of a length of one embodiment of a mechanical clamp 1 constructed in accordance with the invention. The mechanical clamp 1 extends in a longitudinal direction (X) with two planar portions, which extend in a direction substantially perpendicular from each other. The angle between the two planar portions is chosen to fit the angle between the window frame (not shown) and the window glass (not shown), which is typically a right angle. To the extent that the angle is different for any specific windows, the angle between the two planar portions can be adjusted accordingly so that one planar portion fits against the window frame and one fits flush against the window pane.

In FIGS. 2-4, a first planar portion 3 is designed to be attached to a window frame, preferably by screws through screw holes 4 positioned longitudinally along the first planar portion 3. The location of the screw holes 4 (or otherwise the attachment point of the first planar portion 3 to the window frame) can vary. However as discussed below, the position of attachment and the length of the first planar portion 3 effect the function of the mechanical clamp's 1 capability to flex or bend. The planar section is not necessarily flat but is designed to rest against and/or be attached along a portion of a window frame.

The second planar portion 5, when installed, abuts against the interior of the window pane. The film is secured between the window pane and the second planar portion 5. Optionally, a gasket 6 is attached to the second planar portion 5 in between the film and the second planar portion 5 to minimize tearing at the point of contact. The gasket 6 is preferably made of a softer material such as synthetic or natural rubber. The planar section is not necessarily flat but is designed to rest against and/or be attached along a portion of a window pane.

At the point of intersection between the first planar portion 3 and second planar portion 5 is a flex zone 7. The flex zone 7 functions to absorb energy as force (such as from a blast) is applied to the window pane. In the embodiment shown, the flex zone 7 is integral with both the first planar portion 3 and second planar portion 5 of the clamp 1. In the embodiment, the entire clamp 1 is a unitary construction except for the gasket 6. The flex zone 7 is curved to an extent that attachment will bend when force is applied to the window pane (and to the second planar portion 5 by extension). The screw holes 4 in the first planar portion 3 are positioned towards the end of the first planar portion 3 and slightly away from the flex zone 7. This arrangement of screws contributes to the flex zones 7 ability to bend. For best results, it is important not to over drive the screws and the use of self tapping screws is preferable.

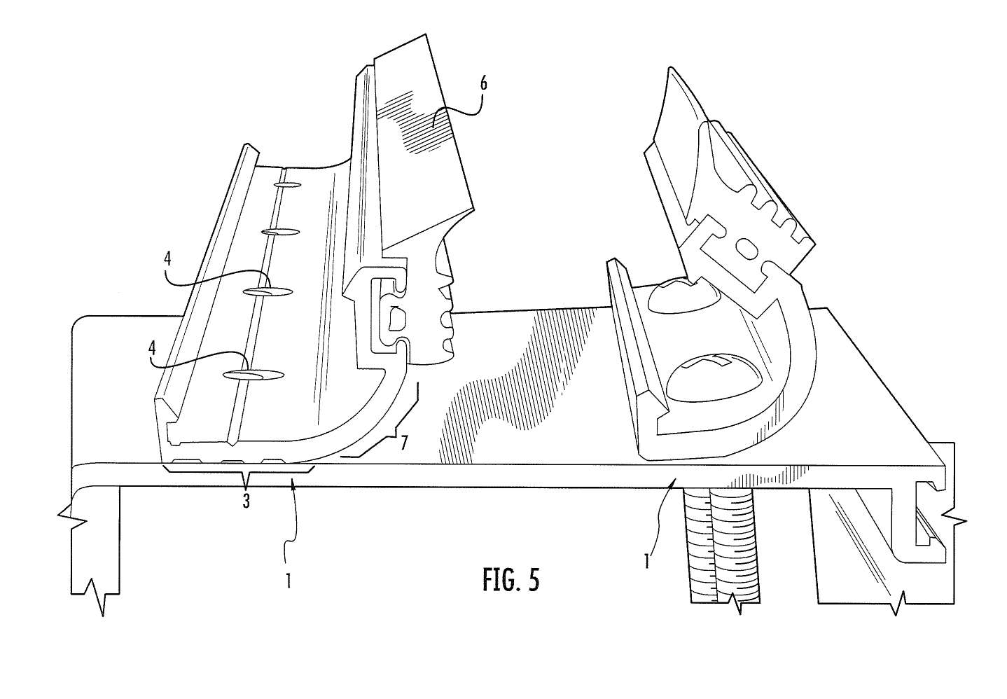

An example of the clamp 1 flexing or bending in response to force is shown in FIG. 5. FIG. 5 illustrates the flexing effect on a mechanical clamp 1 when a window (not shown) is exposed to a blast force. The mechanical clamp 1 on the left is a new mechanical clamp 1. The clamp 1 on the right is a drawing of an actual clamp 1 after a blast load of about 116 PSI. The clamp 1 was tested with annealed glass with safety film (as is typically used in actual application). As can be seen, the clamp 1 remains attached to the frame but is significantly bent in the flex zone 7.

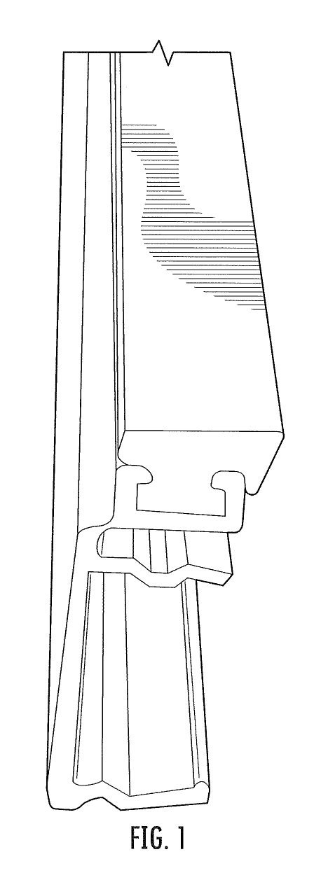

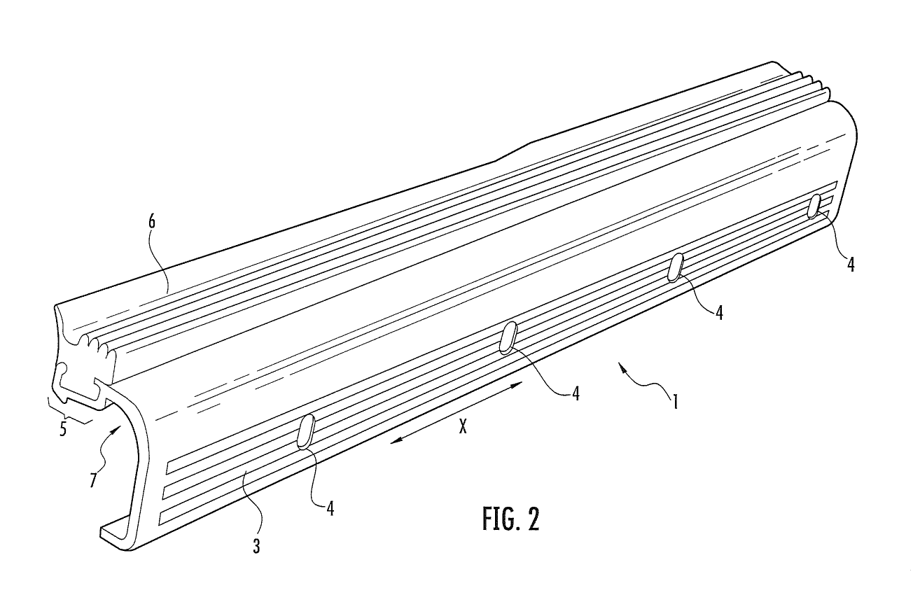

In the embodiment shown, the ability of flex zone 7 to flex or bend in response to a blast is achieved as a function of the degree of curvature in the flex zone 7, which is substantially more pronounced than conventional mechanical attachments (such as that shown in FIG. 1). The position of the screw holes 4 in relation to the flex zone 7 also contributes the capability of the clamp 1 to bend or flex. In the embodiment shown, the clamp 1 is prepared by aluminum extrusion. As shown in FIGS. 2-4, the thickness of the aluminum through the flex zone 7 is substantially the same throughout the entire clamp. The degree of flex is controlled via the thickness and/or configuration of the aluminum flex zone. Thinner aluminum at the flex zone creates greater flexibility for thinner safety films and thicker aluminum can be used for heavier films and higher loads. However, this structure is just one way to achieve the required flexibility in the clamp 1 and other arrangements are possible.

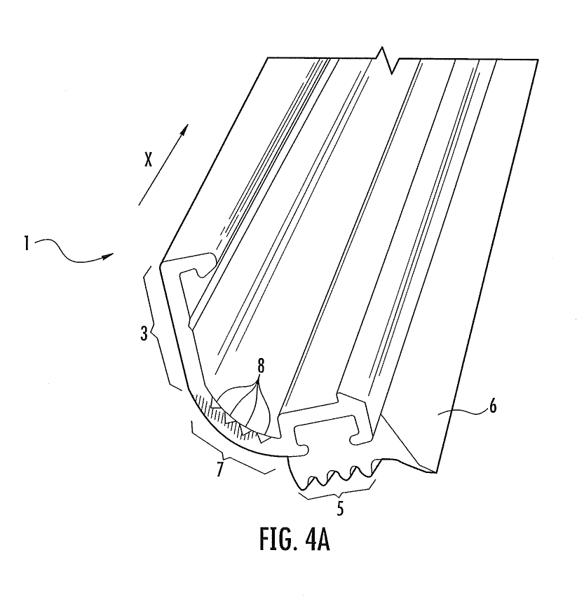

For example, the curvature in the flex zone 7 can be decreased while decreasing the thickness of the clamp 1 at the flex zone 7. For another example different material could be used at the flex zone, such as plastic or composite to increase the flexibility. For another example, notches, cross-cuts or slits can be placed in the curve in order to prompt bending. Other methods of removing material from the flex zone can be implemented. In fact, any combination of the features described herein can be used to achieve the desired flexibility profile of the flex zone. FIG. 4A shows an alternate embodiment where notching 8 the extrusion at the curve in the flex zone 7 alters the flex zone to be able to flex more easily. Four notches are shown in the figure however more or less can be used depending on the desired amount of flex.

### Testing

Tests on various window specimens were performed according to ISO 16933 Open Range Blast Test Protocol. The window construction of three specimens was as follows. The window frame was 1727 mm×1219 mm [68 inches×48 inches] extruded aluminum framed windows of 2.25 mm wall thickness. The style of the windows was fixed lite non-opening shop-front window frame. The glass used was 6 mm annealed float glass on the exterior lite, 12 mm air space and 6.76 mm annealed laminated safety glass. Insulated units mounted into frame with 10 mm edge rebate cover using compression gaskets. Window film used Madico SafetyShield® 800 200 micron multi-ply security grade window film applied to the inside surface of the glass extending onto the window frame by 40 mm and secured in place by an aluminum mechanical clamp constructed in accordance with the invention. The mechanical clamp was attached to the window frame on all four sides using 5.5 mm self drilling screws at 75 mm spacing.

The three test specimens were tested in accordance with classification EXV25 of ISO 16933: standard at a range of 25 meters from the explosive charge. Testing is divided into two categories, EXV which represents vehicle type threats, and SB or satchel bomb type threats meaning small suitcase or backpack size charges situated close in to the building. Under vehicle type testing, the designation denotes the distance the test articles are positioned from the 100 kg, 220 pounds of high explosive e.g. EXV25 denotes the test articles are 25 meters from the explosive charge.

The performance of each of the specimens was as follows. Testing in accordance with EXV25 achieved a GSA Level 3 B, which corresponds to a hazard level of “minimal hazard”. Testing in accordance with EXV19 achieved a GSA Level 3 B4, which corresponds to a hazard level of “low hazard”. Testing in accordance with EXV33 achieved a GSA Level 2, which corresponds to a hazard level of “no hazard”.

A second set of specimens were prepared using stainless steel No. 14 self tapping screws. The three test specimens achieved performance EXV33(B) (No Hazard) when subjected to the detonation of 100 kg TNT at 33 meters standoff in accordance with ISO 16933.

Various other samples were prepared altering the distance between the anchoring screws and the use of wet glaze bead on the external film. Superior performance was achieved in each instance.

There will be various modifications, adjustments, and applications of the disclosed invention that will be apparent to those of skill in the art, and the present application is intended to cover such embodiments. Although the present invention has been described in the context of certain preferred embodiments, it is intended that the full scope of these be measured by reference to the scope of the following claims.

The disclosures of various publications, patents and patent applications that are cited herein are incorporated by reference in their entireties.

What is claimed is:

1. A mechanical attachment for attaching a window film to a window frame comprising:
a means to absorb energy directed to the window when the mechanical attachment is attached to the window frame.

2. The mechanical attachment of claim 1 wherein the means to absorb energy is a flex zone in the mechanical attachment.

3. The mechanical attachment of claim 1 wherein the mechanical attachment further comprises a planar section for attachment to the window frame and a planar section for attachment to the window film.

4. The mechanical attachment of claim 3 wherein the means to absorb energy is a flex zone between the planar section for attachment to the window frame and the planar section for attachment to the window film.

5. The mechanical attachment of claim 4 wherein the flex zone is a curved portion between the two planar sections.

6. The mechanical attachment of claim 5 wherein the attachment is made of extruded aluminum.

7. The mechanical attachment of claim 5 wherein the flex zone has notches.

8. A method for mitigation the blast of a window with film or laminate comprising the steps of:
attaching a mechanical attachment to the frame of the window wherein the mechanical attachment comprises a means to absorb energy directed to the window when the mechanical attachment is attached to the window frame.

9. The method of claim 8 wherein the mechanical attachment of claim 1 wherein the means to absorb energy is a flex zone in the mechanical attachment.

10. The method of claim 9 wherein the mechanical attachment further comprises a planar section for attachment to the window frame and a planar section for attachment to the window film.

11. The method of claim 9 wherein the means to absorb energy is a flex zone between the planar section for attachment to the window frame and the planar section for attachment to the window film.

12. The method of claim 11 wherein the flex zone is a curved portion between the two planar sections.

13. The method of claim 11 wherein the mechanical attachment is made of extruded aluminum.

14. The method of claim 7 wherein the window comprises an external film and the method further comprising the step of applying a wet glaze bead on the external film.

15. The method of claim 12 wherein the flex zone of the mechanical attachment has notches.
